(19) United States
(12) Patent Application Publication
(10) Pub. No.: US 2022/0163069 A1
(43) Pub. Date: May 26, 2022

(54) DISC FOR A MULTI-DISC CLUTCH, MULTI-DISC CLUTCH HAVING THE DISC, AND METHOD FOR PRODUCING THE DISC

(71) Applicant: ZF Friedrichshafen AG, Friedrichshafen (DE)

(72) Inventors: Martin Kaufmann, Friedrichshafen (DE); Frank Siepermann, Argenbühl / Ratzenried (DE); Thomas Schupp, Ravensburg (DE)

(21) Appl. No.: 17/601,646

(22) PCT Filed: Apr. 1, 2020
(86) PCT No.: PCT/EP2020/059262

§ 371 Date: Oct. 5, 2021

(30) Foreign Application Priority Data
Apr. 8, 2019 (DE) 10 2019 204 988.5

(51) Int. Cl. F16D 13/68; F16D 13/64; B21H 1/02

(52) U.S. Cl. CPC F16D 13/683; F16D 13/648; F16D 2250/0076; F16D 2250/003; F16D 2250/0023; B21H 1/02

(57) ABSTRACT

Multi-disc clutches are known which usually have a first clutch pack consisting of steel discs and a second clutch pack consisting of friction discs. A disc for a multi-disc clutch is proposed, which has a disc body. The disc body is in a form of an annular disc, and has a driver contour on its inner circumference and/or outer circumference for mounting the disc in a rotationally fixed manner. The disc body is formed by edgewise rolling on the inner circumference thereof.

### CROSS-REFERENCE TO RELATED APPLICATIONS

This application is a national stage of International Application No. PCT/EP2020/059262, filed Apr. 1, 2020, the disclosure of which is incorporated herein by reference in its entirety, and which claimed priority to German Patent Application No. 102019204988.5, filed Apr. 8, 2019, the disclosure of which is incorporated herein by reference in its entirety.

### TECHNICAL FIELD

The disclosure relates to a disk for a multiple disk clutch. Furthermore, the disclosure also relates to a multiple disk clutch with a plurality of disks, and to a method for producing a disk.

### BACKGROUND

Multiple disk clutches are known which usually have a first multiple disk assembly consisting of steel disks and a second multiple disk assembly consisting of friction disks. Here, the disks of the two multiple disk assemblies are arranged in an alternating sequence, it being possible for the disks to be brought into contact with one another for the formation of a frictionally locking connection, for example between two shafts. The steel disks and the friction disks are usually manufactured as closed rings by way of punching from a metal sheet.

Document DE 10 2015 114 673 A1 discloses a friction disk for a friction clutch, with an annular disk body which is made from steel and is provided with a driver geometry on one of its circumferential edges, the friction faces consisting of the material of the disk body.

What is needed is it is the object of the invention to provide a disk of the type mentioned at the outset, which disk that is distinguished by a particularly inexpensive exemplary arrangement. Furthermore, it is also needed an object of the invention to is a corresponding multiple disk clutch and a method for producing a disk.

### SUMMARY

According to the disclosure, a disk is disclosed. In addition, a multiple disk clutch is also disclosed. Finally, a method for producing a disk is also disclosed.

The disclosure relates to a disk which is configured and/or suitable for a multiple disk clutch. In particular, the disk serves for the formation of a frictionally locking connection and/or non-positive connection in a circumferential direction to at least one or, alternatively, precisely one adjacent disk. The disk can be configured as an intermediate disk or as a friction disk.

In one exemplary arrangement, the disk has a disk body which is configured as an annular disk which, in one exemplary arrangement, runs around a center axis. In one exemplary arrangement, the disk body has a rectangular or at least approximately rectangular cross-sectional profile, an axial dimension of the cross-sectional profile being smaller in relation to the center axis than a radial dimension of the cross-sectional profile. Therefore, the cross-sectional profile of the disk body is oriented in an upright manner in the radial direction in relation to the center axis. In one exemplary arrangement, the disk body is manufactured from a metallic material, and in one exemplary arrangement, from steel.

The disk body has a driver contour on its inner circumference. As an alternative or optionally in addition, the disk body has the driver contour or a further driver contour on its radially outer circumference. In one exemplary arrangement, the inner circumference is defined by way of a radial inner edge which is curved around the center axis, and the outer circumference is defined by way of a radial outer edge of the annular disk, which radial outer edge is curved around the center axis. The driver contour is configured and/or suitable for fixed mounting of the disk for conjoint rotation. In one exemplary arrangement, the driver contour serves for fixed mounting of the disk on a disk carrier and/or shaft with a corresponding mating contour for conjoint rotation. In one exemplary arrangement, the driver contour can be configured as a feather key connection. In one exemplary arrangement, the driver contour is configured, however, as a driver profile which runs around the center axis.

Within the context of the disclosure, it is proposed that in one exemplary arrangement, the disk body is formed by way of vertical edge-rolling on its inner circumference. In particular, in the case of vertical edge-rolling, a linear or preformed (for example, curved) material strip is reshaped plastically, and in one exemplary arrangement, rolled, vertically by a rolling tool about a bending axis to form the annular disk, the center axis corresponding to a bending axis. Here, “vertically” is to be understood to mean that the material strip is reshaped in a radial plane in relation to the bending axis, the material strip being oriented with its rectangular cross-sectional profile in an upright manner in the radial plane. In particular, the rolling tool, for example a roller or roll, is rolled on a longitudinal edge of the material strip in such a way that the material strip experiences constant bending about the center axis. In one exemplary arrangement, the material strip is reshaped by at least approximately 360° about the center axis, with the result that the two end sides of the material strip lie opposite one another in a circumferential direction. The annular disk is therefore formed as a disk-shaped ring which is interrupted, and in one exemplary arrangement, open, in the circumferential direction.

An advantage of the disclosure includes that, in particular, the waste which is produced, in particular, in the case of a punching method which is known from the prior art is reduced considerably or is not produced at all as a result of the vertical edge-rolling. Therefore, the disks can be produced in a particularly material-saving and therefore inexpensive manner. In addition, a production process which saves material and tools is proposed, with the result that the tool costs can additionally be lowered.

It is provided in one exemplary arrangement of the disclosure that the disk body has two end sections which lie opposite one another in the circumferential direction. In particular, the two end sections are defined as two end sides of a material strip. The two end sections can bear against one another in the circumferential direction. In particular, the two end sections bear directly against one another, with the result that the two end sections make contact with one another in a linear manner in the circumferential direction and/or bear flatly against one another. As an alternative, the two end sections can also bear indirectly against one another, however, it being possible, for example, for an intermediate layer, for example an adhesive layer, to be arranged between the two end sections.

As another alternative, the two end sections are spaced apart from one another slightly in the circumferential direction. In particular, “spaced apart slightly” is to be understood such that the two end sections are separated from one another via an air gap. In one exemplary arrangement, the two end sections are arranged spaced apart from one another by less than 1 mm, and even less than 0.5 mm. In one exemplary arrangement, the two end sections are arranged spaced apart less than 0.1 mm.

It is provided in one exemplary arrangement of the disclosure that the two end sections are connected to one another in the circumferential direction by a joining method. The joining method may be selected from one of the method groups in accordance with DIN 8593. In one exemplary arrangement, the end sections are connected to one another in the circumferential direction in a positively locking and/or integrally joined and/or non-positive manner. The two end sections are connected to one another such that they cannot be released or at least can be released in a limited manner.

In one exemplary arrangement, the two end sections are connected to one another by way of welding, and in one exemplary arrangement, joint welding. For example, the two end sections can be connected to one another in an integrally joined manner by way of laser welding.

As an alternative or optionally, the two end sections are connected to one another by way of forming. The two end sections may be connected to one another in a positively locking and/or non-positive manner by way of joining by shearing and upsetting (also called “clinching”).

It is provided in a further exemplary arrangement of the disclosure that the driver contour is made in the disk body by a cutting method. In one exemplary arrangement, the driver contour is made in the disk body by way of chipless cutting. In particular, the driver contour is made in the disk body by way of sectioning, which may be in accordance with DIN 8588. In one exemplary arrangement, the driver contour is made in the disk body after the vertical edge-rolling, and after the joining of the two end sections.

In one exemplary arrangement, the driver contour is made in the disk body by way of precision cutting. As an alternative or optionally, the driver contour is made in the disk body by way of punching. The disk body may be worked in a punch press, the driver contour being made in the disk body by a die. In particular, the disk body is held fixedly by way of what is known as a V-ring plate during the precision cutting.

It is provided in one exemplary arrangement that the driver contour has, in particular in relation to the center axis, a multiplicity of projections and/or cutouts which may be distributed uniformly in the circumferential direction and oriented in the radial direction. In one exemplary arrangement, the projections and/or cutouts can have a round and/or angular and/or pointed, in particular tooth-like, contour. In particular, the driver contour extends in the circumferential direction over the entire inner circumference and/or outer circumference. In one exemplary arrangement, the projections and/or cutouts are arranged distributed in the circumferential direction in such a way that, in particular, the two end sections jointly form, and in one exemplary arrangement, in equal parts, a projection and/or a cutout. Specifically, the driver contour may be configured as a splined joint.

It is provided in a further exemplary arrangement that the disk is configured as a friction disk, the disk body having a friction face at least or precisely on one side, but in one exemplary arrangement, on both sides. In one exemplary arrangement, the friction face extends in a radial plane in relation to the center axis. The friction face may be defined by way of a circular ring face of the annular disk. The friction face can extend over the full surface area over the entire circular ring face. As an alternative, however, the friction face can also extend over the circular ring face in sections and/or in a manner which is interrupted circumferentially. Specifically, the friction face can be integrated directly into the disk body. For example, the friction face can be configured by way of structuring, in particular grooving, which is made in the disk body. As an alternative, the friction face is formed by way of a friction lining which is applied on the at least one side of the disk body. For example, the friction lining can be configured as a paper friction lining.

A further subject matter of the disclosure relates to a multiple disk clutch, in particular for a vehicle, with a plurality of the disks as have already been described above. The multiple disk clutch may be configured as a drive clutch or as a braking clutch. In one exemplary arrangement, the multiple disk clutch which is configured as a drive clutch serves for the interruption of a torque between two shafts. In one exemplary arrangement, the multiple disk clutch which is configured as a braking clutch serves for the generation of a braking torque between a shaft and a stationary component, for example a housing. The multiple disk clutch can be configured as a switchable clutch, as used, for example, in a manual transmission of a motor vehicle. Alternatively, however, the multiple disk clutch can also be configured as a non-switchable multiple disk clutch, as used, for example, as a differential lock in a differential transmission of a motor vehicle.

In accordance with the disclosure, the multiple disk clutch comprises a first multiple disk assembly with disks which have the driver contour on their inner circumference, and a second multiple disk assembly with disks which have the driver contour on their outer circumference. In particular, the disks of the first multiple disk assembly are configured as inner disks which are connected or can be connected to a shaft or an inner disk carrier, for example, fixedly for conjoint rotation but such that they can be displaced axially. In particular, the disks of the second multiple disk assembly are configured as outer disks which are connected and/or can be connected to an internal shaft or an outer disk carrier, for example, fixedly for conjoint rotation but such that they can be displaced axially. In one exemplary arrangement, the disks of the first and/or the second multiple disk assembly are configured as the friction disks. The disks of the first and the second multiple disk assembly are arranged behind one another in an alternating manner. The disks of the first and/or the second multiple disk assembly may be reshaped to form the annular disk by way of vertical edge-rolling of the respective disk body on its inner circumference.

A further subject matter of the disclosure relates to a method for producing a disk as has already been described above. Here, the method comprises the following steps:
providing of elongate metal strip with a first and a second longitudinal edge;
forming of the material strip on one of the two longitudinal edges by way of vertical edge-rolling about a bending axis, with the result that the annular disk body is formed,
an inner circumference being defined by way of the longitudinal edge which is worked by way of vertical edge-rolling, and an outer circumference being defined by way of the other longitudinal edge.

In one exemplary arrangement, the material strip is of a linear and/or band-shaped configuration. In particular, the material strip may be configured as a metal strip, such as a sheet metal strip, specifically as a steel sheet strip. The two longitudinal edges are configured, in relation to a longitudinal axis, as two parallel, and in one exemplary arrangement, rectangular; longitudinal sides of the material strip which are spaced apart from one another by way of a width. In addition, the material strip has two parallel, in particular rectangular, sides, and in one exemplary arrangement, a front side and a rear side which are spaced apart from one another by way of a thickness. “Elongate” is understood such that an axial longitudinal extent of the material strip in relation to the longitudinal axis is multiple times greater than the width of the material strip. The width of the material strip may be multiple times greater than the thickness of the material strip. In particular; the material strip is set upright during forming, with the result that the material strip is arranged with its front and rear side in each case in a radial plane of the bending axis and/or the first and/or second longitudinal edge lies/lie perpendicularly with respect to the radial plane.

In a further method step, after the vertical edge-rolling, the two end sections are connected to one another by way of joining, and in one exemplary arrangement, by way of welding or by way of forming. In an alternative or optionally supplemental method step, after the vertical edge-rolling, the driver contour is made in the disk body by way of cutting, which may be by way of precision cutting and/or punching.

### BRIEF DESCRIPTION OF DRAWINGS

In the following text, the present disclosure will be described further on the basis of the drawing; further advantages, features and effects can be gathered from the description of the figures, in which:

FIG. 1 shows an axial view of a disk for a multiple disk clutch as one exemplary arrangement of the disclosure, and

FIGS. 2a, b show a diagrammatic illustration of a blank of the disk, and a method for producing the blank from FIG. 1.

### DETAILED DESCRIPTION

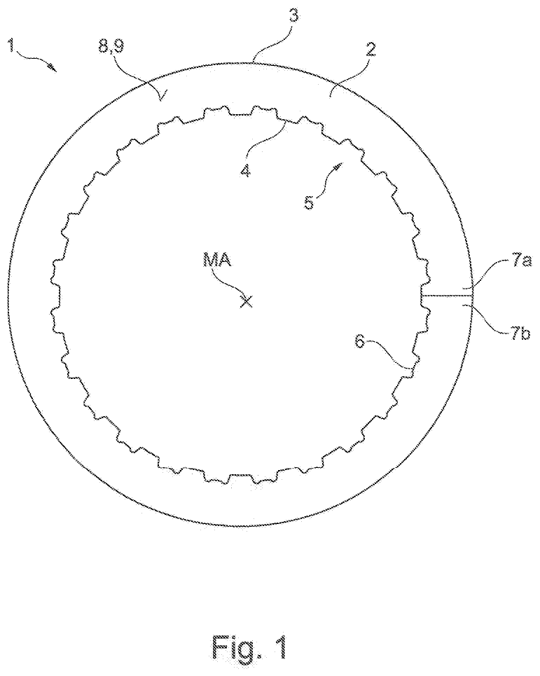

FIG. 1 shows an axial view in relation to a center axis MA of a disk 1 which is configured and/or suitable, for example, for a multiple disk clutch of a vehicle. The disk 1 has a disk body 2 which is configured as an annular disk. For example, in one exemplary arrangement, the disk body 2 is manufactured from a metallic material, in particular steel.

The disk body 2 has an inner and an outer circumference 4, 3, the disk body 2 having a driver contour 5 on its inner circumference 4 for attaching the disk 1 fixedly for conjoint rotation. Therefore, in the exemplary arrangement depicted, the disk 1 is configured as an inner disk, it being possible for the disk 1 to be connected via the driver contour 5 fixedly, for example, to a shaft with a corresponding mating contour or with an inner disk carrier for conjoint rotation. The driver contour 5 is formed by way of a multiplicity of cutouts 6 which are made in the disk body 2 spaced apart from one another uniformly in the circumferential direction around the center axis MA. Therefore, a splined joint is formed which has radially inwardly directed teeth. For example, the cutouts 6 are made in the disk body 2 by way of precision cutting or by way of punching.

The disk body 2 is of interrupted configuration in the circumferential direction around the center axis MA, with the result that a first and a second end section 7a, b are formed. The two end sections 7a, b are arranged so as to lie opposite one another, and together form a tooth of the driver contour 5. For example, the two end sections 7a, b bear against one another in the circulating direction, or are arranged spaced apart from one another slightly. For example, the two end sections 7a, b can be connected fixedly to one another in an integrally joined manner, for example by way of welding or adhesive bonding, or in a positively locking and/or non-positive manner, for example by way of clinching.

For example, the disk 1 is configured as a friction disk, the disk body 2 having a friction face 9 to this end on its side 8, in particular on the front and/or rear side. The friction face 9 is defined by way of a circular ring face of the annular disk-shaped disk body 2 and/or is arranged on said circular ring face. The friction face 9 therefore extends in relation to the center axis MA in a radial plane. For example, the friction face 9 can be integrated into the disk body 2, grid-like structuring, for example, being made to this end in the side 8 of the disk body 2. As an alternative, however, the friction face 9 can also be formed by way of a friction lining (not shown), the friction lining 9 being arranged on the side 8 of the disk body 2, in particular its circular ring face. For example, the friction lining 9 can be formed by way of a coating.

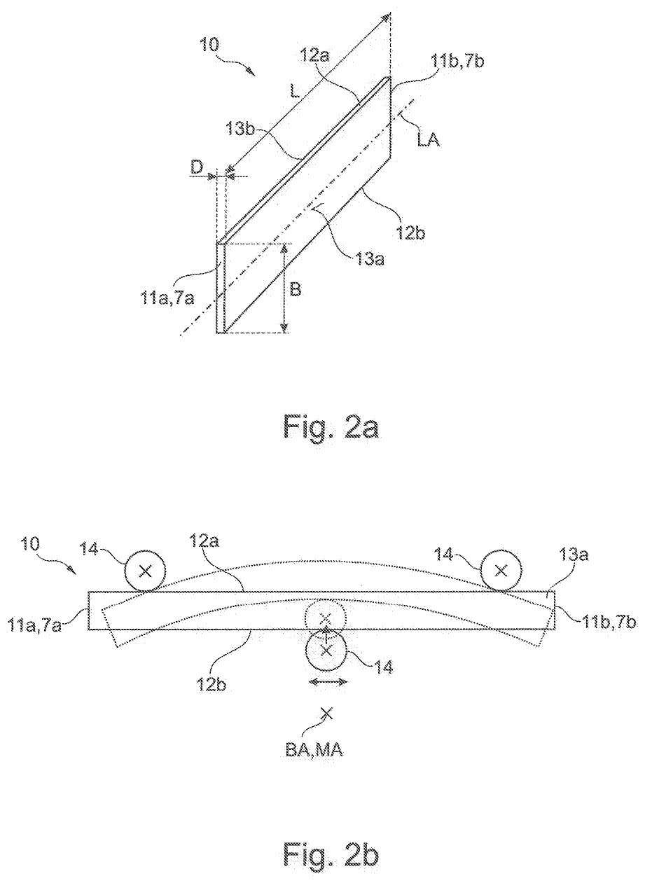

The disk body 2 is worked on its inner circumference 4 by way of vertical edge-rolling, with the result that the disk body 2 is reshaped about the center axis MA to form the annular disk. In the following text, a method for producing the disk body 2 by way of vertical edge-rolling will be described in greater detail on the basis of FIGS. 2a, b.

FIG. 2a diagrammatically shows a perspective illustration of an elongate material strip 10 which forms a blank of the disk 1, from FIG. 1. For example, the material strip 10 is configured as a band-shaped flat steel strip which has an elongate shape in relation to a longitudinal axis LA. In relation to the longitudinal axis LA, the material strip 10 has a first and a second axial end side 11a, b, the first end side 11a forming the first end section 7a, as shown in FIG. 1, and the second end side 11b forming the second end section 7b, as shown in FIG. 1. The two end sides 11a, b are spaced apart from one another by way of a length L in the axial direction in relation to the longitudinal axis LA, and are configured as a rectangular surface. In addition, the material strip 10 has a first and a second longitudinal edge 12a, b, the two longitudinal edges 12a, b being arranged parallel to one another in relation to the longitudinal axis LA, and being spaced apart from one another by way of a width B. Here, the length L of the material strip 10 is multiple times greater than the width B of the material strip 10. The material strip 10 has a front side 13a and a rear side 13b, the front side 13a and the rear side 13b being spaced apart from one another by way of a thickness D. Here, the width B is multiple times greater than the thickness D of the material strip 10.

As shown in FIG. 2b, the material strip 10 is placed upright in relation to a bending axis BA, the material strip 10 extending to this end with its sides 13a, b in each case in a radial plane of the bending axis BA. For reshaping into the annular disk-shaped disk body 2, the material strip 10 is vertically edge-rolled by way of a rolling tool 14, for example, on its second longitudinal edge 12b, with the result that the two longitudinal edges 12a, b are reshaped with a uniform curvature around the bending axis BA, as is indicated diagrammatically by way of dashed illustration. Here, the first longitudinal edge 12a defines the outer circumference 3, and the second longitudinal edge 12b defines the inner circumference 4, as shown in FIG. 1. The material strip 10 is worked by way of the rolling tool 14 until the two end sides 11a, b or the two end sections 7a, b are reshaped by at least approximately 360° around the bending axis BA, with the result that the annular disk is formed and the bending axis BA defines the center axis MA of the disk body 2.

Subsequently, the two end sections 7a, b can be connected to one another in a joining method, and the driver contour 5 can be made in the disk body 2 in a cutting method.

By way of the reshaping of the metal strip 10 by way of vertical edge-rolling, a disk 1 can therefore be manufactured particularly simply, it being possible for waste and therefore the material costs to be reduced considerably in comparison with the punching process which is known from the prior art, 100% of the material which is used can therefore be utilized as a result of the use of vertically edge-rolled material strips 10.

1. A disk for a multiple disk clutch, comprising a disk body, the disk body being configured as an annular disk, and the disk body having, on an inner circumference, a driver contour for fixedly mounting the disk for conjoint rotation, wherein the disk body is formed from vertical edge-rolling on the inner circumference.

2. The disk as claimed in claim 1, wherein the disk body has two end sections which lie opposite one another in a circumferential direction, the two end sections bearing against one another.

3. The disk as claimed in claim 2, wherein the two end sections are connected to one another in the circumferential direction by a joining method.

4. The disk as claimed in claim 1, wherein the two end sections are connected to one another by way of forming.

5. The disk as claimed in claim 1, wherein the driver contour is made in the disk body by a cutting method.

6. The disk as claimed in claim 1, wherein the driver contour is made in the disk body in a manner which is formed by way of precision cutting.

7. The disk as claimed in claim 1, wherein the driver contour has a multiplicity of projections which are distributed uniformly in a circumferential direction and are oriented in a radial direction.

8. The disk as claimed in claim 1, wherein the disk is configured as a friction disk, the disk body having a friction face at least on one side.

9. A multiple disk clutch with a plurality of disks as claimed in claim 1, further comprising a first multiple disk assembly with first disks which have the driver contour on their inner circumference, and by a second multiple disk assembly with second disks which have a driver contour on their outer circumference, the first and second disks of the first and the second multiple disk assembly being arranged behind one another in an alternating manner.

10. A method for producing a disk comprising:
providing an elongate metal strip with a first and a second longitudinal edge;
vertical edge-rolling the metal strip about a bending axis on one of the two longitudinal edges so as to form a disk body,
forming an inner circumference of the disk body, which is defined by way of the longitudinal edge that is worked by way of vertical edge-rolling, and
forming an outer circumference of the disk body, which is defined by way of the other longitudinal edge (12a, 12b).

11. The method as claimed in claim 10, wherein after the vertical edge-rolling, two end sections of the metal strip are connected to one another by way of joining.

12. The method as claimed in claim 10, wherein, after the vertical edge-rolling, the driver contour is made in the annular disk body by way of cutting.

13. The disk as claimed in claim 1, wherein the disk body has two end sections which lie opposite one another in a circumferential direction, the two end sections being spaced apart from one another slightly in the circumferential direction.

14. The disk as claimed in claim 2, wherein the two end sections are connected to one another by way of welding.

15. The disk as claimed in claim 1, wherein the driver contour is made in the disk body in a manner which is formed by punching.

16. The disk as claimed in claim 7, wherein the driver contour further has a multiplicity of cutouts which are distributed uniformly in the circumferential direction and are oriented in the radial direction.

17. The disk as claimed in claim 1, wherein the driver contour has a multiplicity of cutouts which are distributed uniformly in a circumferential direction and are oriented in a radial direction.

18. The method as claimed in claim 11, wherein, after the vertical edge-rolling, the driver contour is made in the annular disk body by way of cutting.

19. The method as claimed in claim 11, wherein the end sections are fixedly connected to one another by welding.

20. The method as claimed in claim 10, wherein after the vertical edge-rolling, two end sections of the metal strip are arranged so as to lie opposite one another, but spaced apart from one another slightly to form a gap therebetween.
